(19) United States
(12) Patent Application Publication
(10) Pub. No.: US 2016/0092822 A1
(43) Pub. Date: Mar. 31, 2016

(54) METHODS AND SYSTEMS FOR APPLYING A CONTINUOUS IMPROVEMENT PROCESS TO TALENT

(71) Applicant: HRM Direct, Inc., Boston, MA (US)

(72) Inventors: Andre G. Lavoie, San Francisco, CA (US); Colin William Kingsbury, Boston, MA (US)

(21) Appl. No.: 14/859,772

(22) Filed: Sep. 21, 2015

Related U.S. Application Data
(60) Provisional application No. 62/055,711, filed on Sep. 26, 2014.

(51) Int. Cl. G06Q 10/06; G06Q 10/10; G09B 7/00

(52) U.S. Cl. CPC G06Q 10/06398; G09B 7/00; G06Q 10/1053

(57) ABSTRACT

A computer-implemented method includes assessing each of a plurality of workers, using an assessment test evaluating a plurality of performance characteristics. The method includes correlating each assessment with actual performance by each of the plurality of workers. The method includes identifying at least one highly-correlated leading indicator of performance. The method includes modifying a hiring process to incorporate the identified at least one highly-correlated leading indicator of performance. The method includes providing to a candidate for hire, an assessment test including at least one question aimed at determining whether the candidate for hire possesses the identified at least one highly-correlated leading indicator of performance. The method includes evaluating whether the candidate for hire demonstrates the identified at least one highly-correlated leading indicator of performance. The method includes determining whether to hire the candidate based on the evaluation.

### CROSS-REFERENCE TO RELATED APPLICATIONS

This application claims priority from U.S. Provisional Patent Application No. 62/055,711, filed on Sep. 26, 2014, entitled “Methods and Systems for Applying a Continuous Improvement Process to Talent,” which is hereby incorporated by reference.

### BACKGROUND

The disclosure relates to improving talent at an organization. More particularly, the methods and systems described herein relate to applying a continuous improvement process to talent.

Conventional systems and methodologies for improving an organization's talent (e.g., the fit of a candidate into an organization) typically leverage an understanding of top and bottom performers in an organization at a point in time and then incorporate that information about the success or failure of the measured employees into a hiring process to improve the quality of talent brought into the organization by looking at how candidates line up against the qualities of these existing performers. However, these systems do not typically provide functionality for accounting for the dynamic nature of an organizational structure that renders assessments against a point-in-time structure moot. For example, a company with 10% turnover will have as much as 50% of its people replaced with new employees in as short as a five-year period. Further, companies reorganize and restructure often, changing the dynamics of the organization that lead to performance including hierarchy, organizational structure, size of team, location of teams and so on. These occurrences happen regularly in most organizations and often abruptly change the organizational structure.

A conventional system that does not allow for continual evaluation and assessment of performance or the correlation of key indicators of performance in-role in the group that makes up the cohort—the team, department, office, location, or company that the candidate-to-be will be incorporated into—cannot take into account the changes in the qualities of the top and bottom performers and the assessment of how to qualify top performers or correlate their key success factors to performance Therefore, the data that is used loses relevance for assessing fit and performance at the time of the candidate-for-hire assessment. This is because the factor that contributes most to performance assessment is organizational structure including the likes of the manager, peers and reports contributing to performance evaluations, and the demographic data, as they exist at the time of assessing candidates-for-hire. Further, the correlation of key performance indicators with performance changes as the team's structure and demographics change.

### BRIEF SUMMARY

In one aspect, the methods and systems described herein incorporate information about the likelihood of an employee performing in an organization in real-time based on the organization's structure and the performance of the individuals, and their key performance factors and demographics who exist in that structure as it exists at the time of candidate assessment and, since it can be run instantly, the data do not lose significance as a conventional process would (i.e., almost as quickly as it is produced). The system also accounts for turnover as it automatically incorporates the performance of individuals who are entering into the system via the process of hiring and recruitment and takes into account the changes they make to the cohort itself. Providing a quantitative approach to assessment may result in a system in which comparative scores across candidates are based on indicators quantitatively most linked with success, even as the definition of success shifts over time. From a new-hire perspective, one embodiment of the methods and systems described herein also provides important feedback to the entire continuous improvement process by measuring the performance of new entrants into the system and assessing how these new entrants perform as a separate cohort in and of itself.

In one aspect, a method performed by at least one computer processor executing computer program instructions stored on at least one non-transitory computer-readable medium, wherein the computer program instructions are executable by the at least one computer processor to perform a method including assessing, by a performance management module executed by the computer processor, each of a plurality of workers, using an assessment test evaluating a plurality of performance characteristics. The method includes correlating, by the performance management module, each assessment with actual performance by each of the plurality of workers. The method includes identifying, by the performance management module, at least one highly-correlated leading indicator of performance. The method includes modifying, by an applicant tracking module executed by the computer processor, a hiring process to incorporate the identified at least one highly-correlated leading indicator of performance. The method includes providing, by the applicant tracking module, to a candidate for hire, an assessment test including at least one question aimed at determining whether the candidate for hire possesses the identified at least one highly-correlated leading indicator of performance. The method includes evaluating, by the applicant tracking module, whether the candidate for hire demonstrates the identified at least one highly-correlated leading indicator of performance. The method includes determining, by the applicant tracking module, whether to hire the candidate based on the evaluation.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-1C are block diagrams depicting embodiments of computers useful in connection with the methods and systems described herein;

FIG. 2 is a block diagram depicting an embodiment of a system for applying a continuous improvement process to talent;

FIG. 3A is a flow diagram depicting an embodiment of a method for applying a continuous improvement process to talent;

FIG. 3B is a flow diagram depicting an embodiment of a method for applying a continuous improvement process to talent; and

FIG. 3C is a block diagram depicting one embodiment of a display generated by a performance management module.

### DETAILED DESCRIPTION

In some embodiments, the methods and systems described herein provide functionality for applying a continuous improvement process to talent. Before describing these methods and systems in detail, however, a description is provided of a network in which such methods and systems may be implemented.

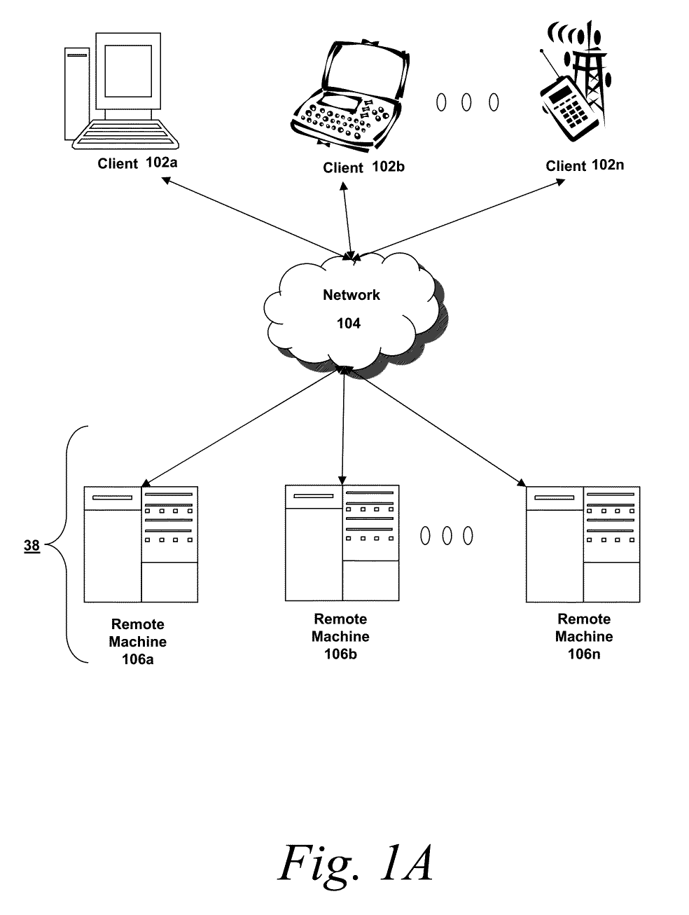

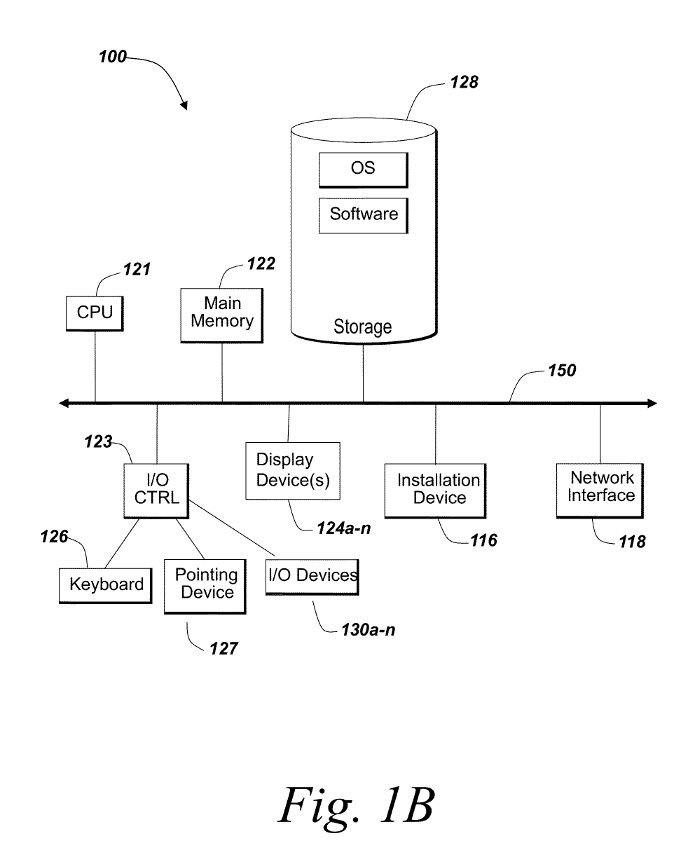

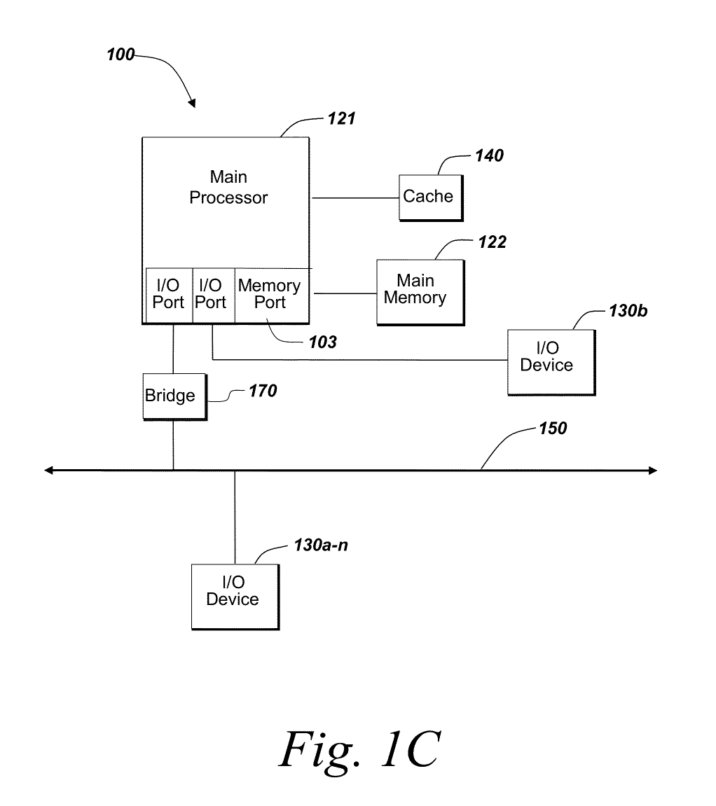

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 102 and a remote machine 106 (referred to generally as computing devices 100) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, an ActiveX control, or a JAVA applet, or any other type and/or form of executable instructions capable of executing on client 102.

In one embodiment, a computing device 106 provides functionality of a web server. In some embodiments, a web server 106 comprises an open-source web server, such as the APACHE servers maintained by the Apache Software Foundation of Delaware. In other embodiments, the web server executes proprietary software, such as the Internet Information Services products provided by Microsoft Corporation of Redmond, Wash., the ORACLE iPlanet web server products provided by Oracle Corporation of Redwood Shores, Calif., or the BEA WEBLOGIC products provided by BEA Systems of Santa Clara, Calif.

In some embodiments, the system may include multiple, logically-grouped remote machines 106. In one of these embodiments, the logical group of remote machines may be referred to as a server farm 38. In another of these embodiments, the server farm 38 may be administered as a single entity.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. Other examples include SPARC processors, ARM processors, processors used to build UNIX/LINUX “white” boxes, and processors for mobile devices. The computing device 100 may be based on any of these processors, or any other processor capable of operating as described herein.

Main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. The I/O devices may be controlled by an I/O controller 123 as shown in FIG. 1B. Furthermore, an I/O device may also provide storage and/or an installation medium 116 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 1B, the computing device 100 may support any suitable installation device 116, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 100 may provide functionality for installing software over a network 104. The computing device 100 may further comprise a storage device, such as one or more hard disk drives or redundant arrays of independent disks, for storing an operating system and other software. Alternatively, the computing device 100 may rely on memory chips for storage instead of hard disks.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, and WINDOWS VISTA, all of which are manufactured by Microsoft Corporation of Redmond, Wash.; MAC OS manufactured by Apple Inc. of Cupertino, Calif.; OS/2 manufactured by International Business Machines of Armonk, N.Y.; LINUX, a freely-available operating system distributed by Caldera Corp. of Salt Lake City, Utah; Red Hat Enterprise Linux, a LINUX-variant operating system distributed by Red Hat, Inc. of Raleigh, N.C.; Ubuntu, a freely-available operating system distributed by Canonical Ltd. of London, England; or any type and/or form of a UNIX operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device. In other embodiments the computing device 100 is a mobile device, such as a JAVA-enabled cellular telephone/smartphone or personal digital assistant (PDA). The computing device 100 may be a mobile device such as those manufactured, by way of example and without limitation, by Apple Inc. of Cupertino, Calif.; Google/Motorola Div. of Ft. Worth, Tex.; Kyocera of Kyoto, Japan; Samsung Electronics Co., Ltd. of Seoul, Korea; Nokia of Finland; Hewlett-Packard Development Company, L.P. and/or Palm, Inc. of Sunnyvale, Calif.; Sony Ericsson Mobile Communications AB of Lund, Sweden; or Research In Motion Limited of Waterloo, Ontario, Canada. In yet other embodiments, the computing device 100 is a smartphone, POCKET PC, POCKET PC Phone, or other portable mobile device supporting Microsoft Windows Mobile Software.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices manufactured by Apple Inc. In another of these embodiments, the digital audio player may function as both a portable media player and as a mass storage device. In other embodiments, the computing device 100 is a digital audio player such as those manufactured by, for example, and without limitation, Samsung Electronics America of Ridgefield Park, N.J., or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats, and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a device in the Google/Motorola line of combination digital audio players and mobile phones. In another of these embodiments, the computing device 100 is a device in the IPHONE smartphone line of devices manufactured by Apple Inc. In still another of these embodiments, the computing device 100 is a device executing the ANDROID open source mobile phone platform distributed by the Open Handset Alliance; for example, the device 100 may be a device such as those provided by Samsung Electronics of Seoul, Korea, or HTC Headquarters of Taiwan, R.O.C. In other embodiments, the computing device 100 is a tablet device such as, for example and without limitation, the IPAD line of devices manufactured by Apple Inc.; the PLAYBOOK manufactured by Research In Motion; the CRUZ line of devices manufactured by Velocity Micro, Inc. of Richmond, Va.; the FOLIO and THRIVE line of devices manufactured by Toshiba America Information Systems, Inc. of Irvine, Calif.; the GALAXY line of devices manufactured by Samsung; the HP SLATE line of devices manufactured by Hewlett-Packard; and the STREAK line of devices manufactured by Dell, Inc. of Round Rock, Tex.

In some embodiments, an infrastructure may extend from a first network—such as a network owned and managed by an individual or an enterprise—into a second network, which may be owned or managed by a separate entity than the entity owning or managing the first network. Resources provided by the second network may be said to be “in a cloud.” Cloud-resident elements may include, without limitation, storage devices, servers, databases, computing environments (including virtual machines, servers, and desktops), and applications. For example, an administrator of a machine 106a on a first network may use a remotely located data center to store servers 106b-n (including, for example, application servers, file servers, databases, and backup servers), routers, switches, and telecommunications equipment. The data center may be owned and managed by the administrator of the machine 106a on the first network, or a third-party service provider (including for example, a cloud services and hosting infrastructure provider) may provide access to a separate data center. Embodiments implementing such distributed infrastructure may be used to provide software as a service, and, in some instances, the distributed infrastructure allows for multi-tenant software as a service.

In one aspect, the methods and systems described herein provide functionality for integrating data associated with an employee's company performance into a measurable, automatable hiring process. In one embodiment, use of such methods and systems improve the probability that a virtuous cycle is created during a hiring process, as opposed to a status quo or vicious hiring process.

In one embodiment, the methods and systems described herein provide functionality for assessing an organization's current employees (according to any rubric), correlating those assessments with actual performance (e.g., using manager evaluations or goal attainment), identifying the most highly-correlated leading indicators of performance, and applying those highly-correlated leading indicators to a hiring process; functionality may also be provided for benchmarking recent hires against incumbents to validate whether a level of talent at the organization is improving. Leading indicators of performance may also be referred to as key performance indicators. In another embodiment of the methods and systems described herein, the system may either view candidate evaluations as equally weighted (e.g., equal weighting of interviewee's responses to n questions) or weighted by correlation with past performance (e.g., answers to certain questions being assigned greater value than answers to other questions). In still another embodiment, the methods and systems described herein provide functionality for combining, with a hiring process, information about people who perform well in roles in order to improve the probability of creating a virtuous hiring cycle.

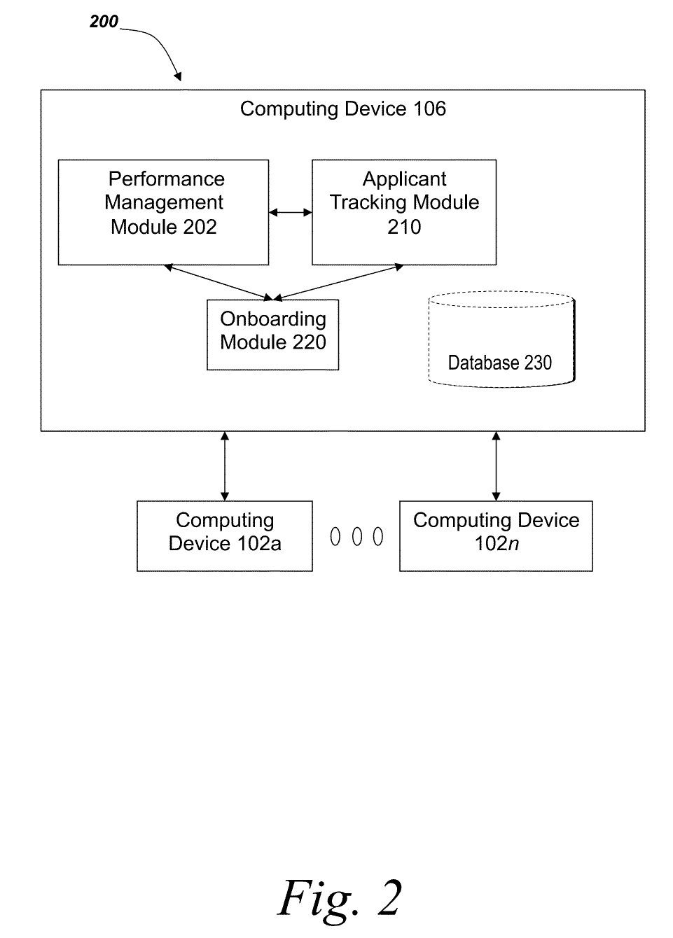

Referring now to FIG. 2, a block diagram depicts one embodiment of a system 200 for applying a continuous improvement process to talent. In brief overview, the system 200 includes computing devices 102a-102n (referred to generally as computing devices 102) and a computing device 106. The computing device 106 executes a performance management module 202, an applicant tracking module 210, and an onboarding module 220.

Referring now to FIG. 2, and in greater detail, the computing devices 102 and 106 may be provided as machines 100, as described above in reference to FIGS. 1A-1C. The computing device 106 may be a set of such machines 100 working together as a single unit. The computing device 106 may comprise a first machine 106a that executes software performing the methods set forth below, combined with a second machine 106b specializing in data storage. The computing devices 102 and 106 may communicate over a network 104 as described above in connection with FIGS. 1A-1C.

The system 200 includes the performance management module 202, which may execute on the computing device 106. In one embodiment, the performance management module 202 is provided as a software application. In another embodiment, the performance management module 202 is provided as a hardware application. The performance management module 202 may be in communication with the applicant tracking module 210. The performance management module 202 may be in communication with the onboarding module 220. In conjunction with the applicant tracking module 210 and the onboarding module 220, the performance management module 202 allows users to capture an identification of a level of quality of an onboarding process and an identification of a level of quality of a hiring process, reporting independently of a performance review in the form of time-based surveys, performance or “360” reviews that are triggered for each employee by the onboarding module 220 after a predetermined time period of being hired.

In one embodiment, the performance management module 202 provides functionality for automating a process of capturing one or more characteristics of talented employees in order to distinguish top performers from other performers. In another embodiments, the performance management module 202 provides functionality for systematically assessing whether that talent is improving over time by running the same performance review against an organization's population of employees and new hires over time.

The system 200 includes the applicant tracking module 210, which may execute on the computing device 106. In one embodiment, the applicant tracking module 210 is provided as a software application. In another embodiment, the applicant tracking module 210 is provided as a hardware application.

In one embodiment, the applicant tracking module 210 provides functionality for generating assessment tests and/or performance reviews based on metrics identified by the performance management module 202 (e.g., highly correlated leading indicators of top performance). In another embodiment, the applicant tracking module 210 provides functionality for generating and providing, to a user of the system 200, a profile of the ideal candidate for a particular role for both the recruiter and interested parties (e.g., hiring managers or peers that were included in the hiring process), to help distinguish during the qualitative process of establishing the requirements for the position or the screening of candidates.

The system 200 includes the onboarding module 220, which may execute on the computing device 106. In one embodiment, the onboarding module 220 is provided as a software application. In another embodiment, the onboarding module 220 is provided as a hardware application.

Although for ease of discussion the performance management module 202, the applicant tracking module 210, and the onboarding module 220 are described as separate modules, it should be understood that this does not restrict the architecture to a particular implementation. For instance, a single circuit or software function may encompass these modules; as another example, the functionality of one or more components may be distributed across multiple components or computing devices.

The system 200 may include a database 230, shown in shadow in FIG. 2. In one embodiment, the computing device 106 includes the database 230. In another embodiment, the computing device 106 is in communication with a second computing device 106b (not shown) that includes the database 230. In some embodiments, the database 230 is an ODBC-compliant database. For example, the database may be provided as an ORACLE database manufactured by Oracle Corporation of Redwood Shores, Calif. In other embodiments, the database can be a Microsoft ACCESS database or a Microsoft SQL server database manufactured by Microsoft Corporation of Redmond, Wash. In still other embodiments, the database may be a custom-designed database based on an open source database, such as the MYSQL family of freely available database products distributed by MySQL AB Corporation of Uppsala, Sweden. In other embodiments, examples of databases include, without limitation, structured storage (e.g., NoSQL-type databases and BigTable databases), HBase databases distributed by The Apache Software Foundation of Forest Hill, Md., MongoDB databases distributed by 10Gen, Inc. of New York, N.Y., and Cassandra databases distributed by The Apache Software Foundation. In further embodiments, the database may be any form or type of database.

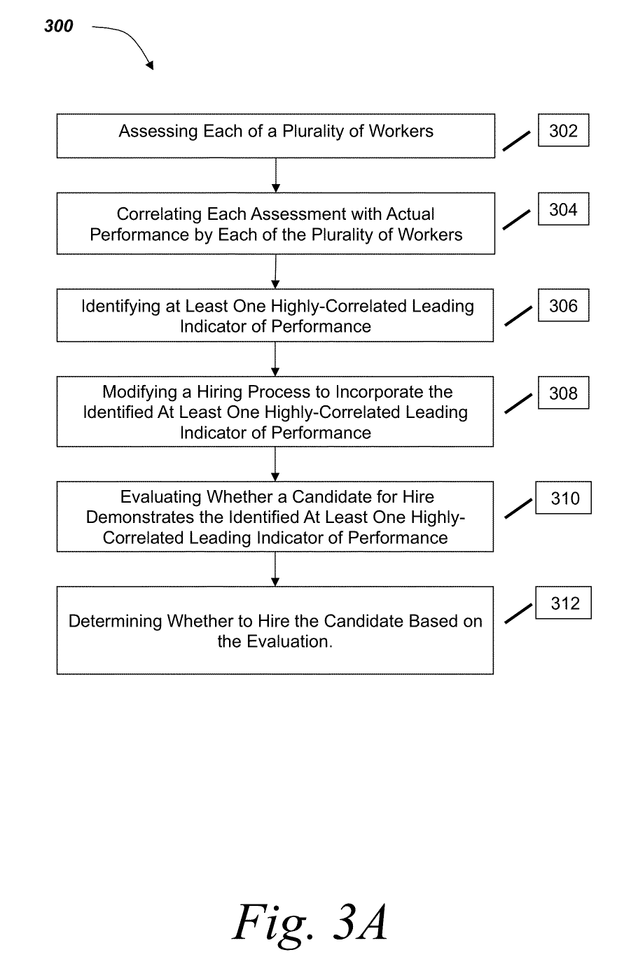

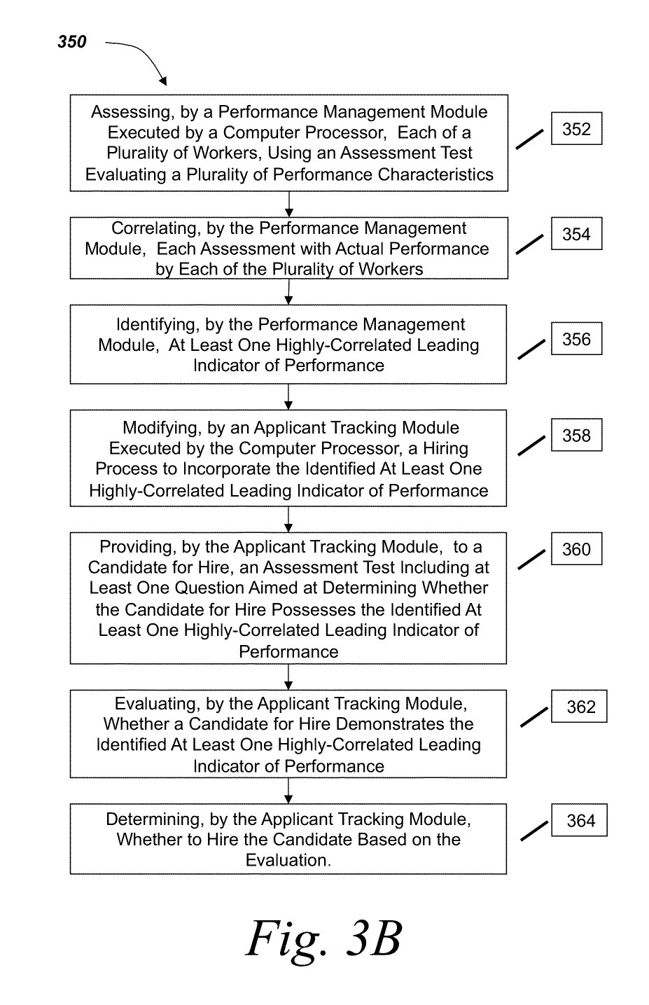

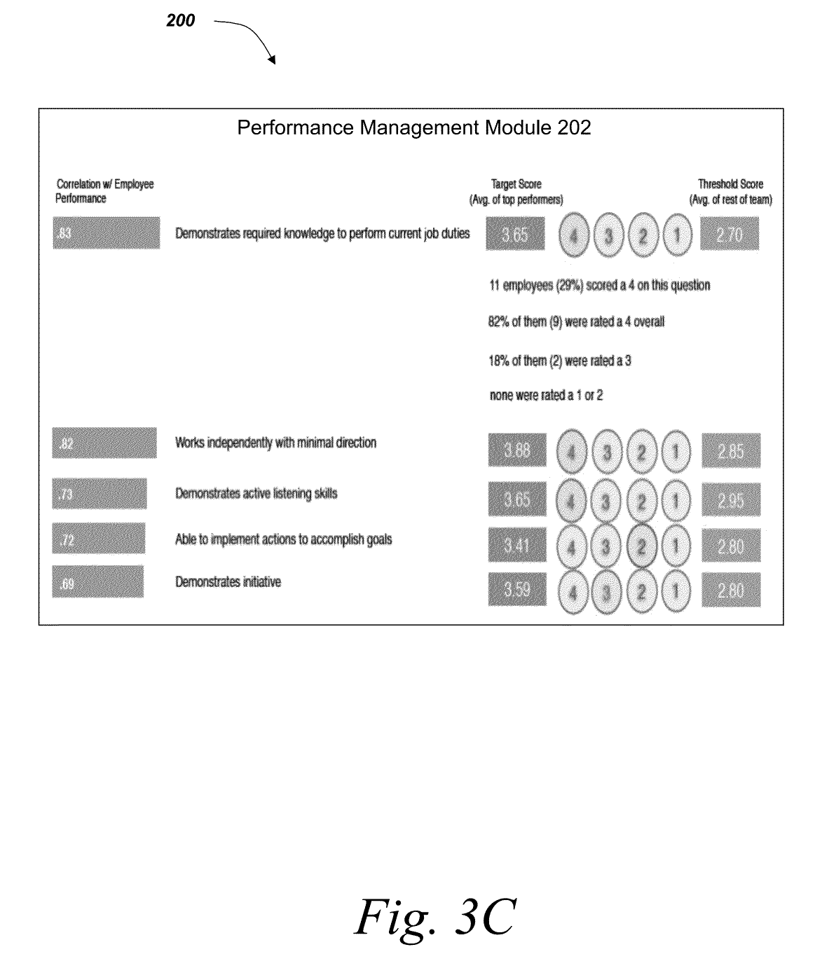

Referring now to FIG. 3A, and in connection with FIG. 2, a flow diagram depicts one embodiment of a method for applying a continuous improvement process to talent. The method 300 includes assessing each of a plurality of workers (302). The method 300 includes correlating each assessment with actual performance by each of the plurality of workers (304). The method 300 includes identifying at least one highly-correlated leading indicator of performance (306). The method 300 includes modifying a hiring process to incorporate the identified at least one highly-correlated leading indicator of performance (308). The method 300 includes evaluating whether a candidate for hire demonstrates the identified at least one highly-correlated leading indicator of performance (310). The method 300 includes determining whether to hire the candidate based on the evaluation (312).

Referring now to FIG. 3A, in greater detail and in connection with FIG. 2, the method 300 includes assessing each of a plurality of workers (302). In one embodiment, the system 200 provides functionality for learning from company performance. In another embodiment, the performance management module 202 analyzes performance data to identify one or more factors that differentiate top performers from bottom performers, average performers, and/or all other performers in an organization. In still another embodiment, the system 200 provides functionality for receiving data from performance reviews. In another embodiment, the system 200 provides functionality for receiving data from assessment tests. By way of example, and without limitation, the system 200 may provide a database 230 for storing assessment data, such as performance review data or assessment test results. As another example, the system 200 may provide, or be in communication with, a system for assessing worker performance towards a task, goal, objective, or mission. For example, and without limitation, the system 200 may provide, or be in communication with, a system providing functionality such as that described in commonly-owned, co-pending U.S. patent application Ser. No. 14/312,734, filed on Jun. 24, 2014, entitled, “Methods and Systems for Understanding the Allocation of Resources to Goals,” which is hereby incorporated by reference. Continuing with this example, the performance data may be based on a review that would likely include a manager review of the employee based on the employee's ability to achieve particular goals as described in the above-identified patent application. In another embodiment, performance data is based on competencies or values (and, therefore, the system may use competencies as a basis for identified performance data), or an ability to achieve goals that were set directly by the manager. In further embodiments, performance data involves a review by the manager, peers and sometimes direct reports, depending on the thoroughness of a 360 review incorporated into a performance assessment. In some embodiments, a user (e.g., a manager) can specify an existing competency or new competency to use in assessing workers.

The method 300 includes correlating each assessment with actual performance by each of the plurality of workers (304). In one embodiment, the performance management module 202 separates performers who rank higher than others (“top performers”) from performers who rank lower than others (e.g., bottom performers, average performers, or all other performers). In one embodiment, top performers receive a final score that puts them in the top quadrant, quintile, etc., or other category as designated by the performance review. The scale may be based on a review process that is put in place by users of the system (e.g., the organization employing the performers) and may be either an existing system or one generated by functionality provided by the system 200 that enables users to build any scale the organization wants and any questions, competencies, or sections the organization wants based on their own method for assessing performance Such a system may but is not required to, give an existing employee a “Final review score.” In another embodiment, the system 200 provides functionality that leverages such a final review score to separate these top performers from the rest of the performance group to either 1) study to create an assessment that includes their properties, or 2) use to identify the average, high and low scores of those performers to use as a benchmark when incorporating the correlated performance questions into the candidate assessments. The system 200 can also use any plurality of members of the remaining group, or the average of the entire group, or the bottom n users on the scale to create a bottom threshold that one should not hire under that represents someone who would represent a less than desirable or ‘average’ or ‘below average’ performer.

Referring ahead to FIG. 3C, a block diagram depicts one embodiment of a display generated by the performance management module 202. As shown in FIG. 3C, the display lists one or more questions on which employees were scored, lists correlation of the question with the employee performance, and provides additional detail regarding the correlation and the scores. For example, and as shown in FIG. 3C, the performance management module 202 may indicate a target score that is an average of top performers. As another example, the performance management module 202 may provide additional detail as to how each employee was rated for one or more questions. As a further example, the performance management module 202 may identify a threshold score below which a candidate or employee would not qualify for a role.

Referring back to FIG. 3A, and in one embodiment, the performance management module 202 uses a systematic approach (e.g., regression or correlation analysis) to analyze questions on a performance review to identify how the results of answers correlate with overall performance (e.g., with whether the performance review respondent is a top performer or a bottom performer). In another embodiment, the performance management module 202 provides functionality (e.g., a user interface) allowing a user to set a benchmark for top, mid and low performers, based on correlation to performance of questions from the individuals who took the review as filtered by criteria, such as division, office, location, or team.

In one embodiment, the performance management module 202 analyzes at least one attribute of a plurality of top performers to identify qualities and traits and other characteristics of top performers. In another embodiment, the performance management module 202 associates each identified characteristic with an assessment test built to focus on the identified characteristics. For example, an organization's employees may be required to take one or more assessment tests including one or more questions and the performance management module 202 may associate each question in the assessment test with a characteristic associated with the plurality of top performers. As another example, the performance management module 202 could divide an organization into quintiles, deciles, or other sub-divisions to split the top performers from the bottom performers and then review the difference in scores on the assessment tests of top performers from the scores of bottom performers to establish a benchmark or minimum acceptable score to be considered a top performer. In one embodiment, the performance management module 202 may provide functionality allowing users to select existing employees for new assignments (e.g., since the performers are already categorized, a user may review a listing of performers and select the type of performer needed for a particular assignment).

The method 300 includes identifying at least one highly-correlated leading indicator of performance (306). By analyzing the identified characteristics of top performers, the performance management module 202 may identify at least one highly-correlated leading indicator of performance. That is, having reviewed performance review data and assessment data and compared that data with a measure of an actual performance of an organization's employees (and whether each employee is a top performer or a bottom performer) and having identified characteristics of the top performers based on the comparison, the performance management module 202 may then determine which of the identified characteristics are most highly correlated with high performance That leading indicator of performance may then be used to improve a hiring process of the organization.

The method 300 includes modifying a hiring process to incorporate the identified at least one highly-correlated leading indicator of performance (308). The applicant tracking module 210 may access data generated by the performance management module 202. In one embodiment, the applicant tracking module 210 receives the at least one highly-correlated leading indicator of performance. During a stage in the hiring process focused on role definition and the initial screening, the applicant tracking module 210 may generate a profile of an ideal candidate for a task or job, based on the identified at least one highly-correlated leading indicator of performance. In some embodiments, the applicant tracking module 210 receives a requisition for a role (including, by way of example and without limitation, a description of one or more tasks associated with the job) and identifies one or more top performers that have previously completed similar jobs; the applicant tracking module 210 may then retrieve the at least one highly-correlated leading indicator of performance derived from the performance management module 202's analysis of the identified top performer or performers to generate the profile.

In one embodiment, selecting a cohort of top performers from which to derive the highly correlated indicator in order to assess a new candidate includes identifying the organizational structure surrounding a hiring manager (e.g., the employee who will be managing the new candidate) who manages a team, is on a team, or has reports in a location or office. This organizational structure may be considered in the process of screening the top correlated performance questions and the average scores of the top performers. The system may then broaden or narrow the filters that identify the correlated questions and the top performing scores by changing the filters on the correlated results. Correlated key performance indicators that are identified by the hierarchical structure surrounding the hiring manager may be used to construct a more accurate job description that includes the indicators of what one must do well at in order to ultimately perform well at the job.

The applicant tracking module 210 may provide the profile to a recruiter or other user of the system 200 (human or otherwise). In one embodiment, the profile is filterable by criteria, such as division, office, location, or team. In another embodiment, the profile helps a user of the system 200 understand the types of qualities that an ideal candidate would have.

The method 300 includes evaluating whether a candidate for hire demonstrates the identified at least one highly-correlated leading indicator of performance (310). In one embodiment, an assessment test may be provided to a candidate for hire. In another embodiment, the applicant tracking module 210 generates the assessment test. For example, the applicant tracking module 210 may access a requisition for a role (including, for example, one or more tasks to be done by the entity responsible for completing the job), identify one or more top performers that have previously completed similar jobs, retrieve the at least one highly-correlated leading indicator of performance derived from the performance management module 202's analysis of the identified top performer or performers, and generate an assessment test including questions aimed at determining whether the candidate possesses the identified leading indicators of performance.

In one embodiment, multiple people in an organization contribute to a performance review of the candidate; the system 200 then produces the results—the final scores by interviewer, the averages of each question and final summed score by all the participants in the loop. The system 200 produces the individual scores and final scores weighted based on the questions' correlation to performance in the role. In some embodiments, the system 200 may also produce an un-weighted score in order to demonstrate that candidate feedback without considering a weighting based on the questions correlation to actual performance in the role lacks the necessary depth to provide a useful analysis.

The method 300 includes determining whether to hire the candidate based on the evaluation (312). In one embodiment, the applicant tracking module 210 makes the determination. In one embodiment, assessment tests are inserted into the hiring process (which may include, by way of example and without limitation, an online application process), automatically routing applicants further into the hiring process if they pass or qualify for the minimum acceptable score. Therefore, the system 200 evaluates whether candidates for hire demonstrate the identified at least one highly-correlated leading indicator of performance and use that evaluation to determine whether to hire the candidate.

In one embodiment, the questions and qualities of the ideal candidate could be added directly into a 360 feedback loop process with hiring managers' quantitative feedback that would result in a score that would then take into account the weighted correlation or regression analysis against top performers resulting in a more accurate depiction of the best candidate for the role.

Referring now to FIG. 3B, and in connection with FIGS. 2, 3A, and 3C, a flow diagram depicts one embodiment of a method for applying a continuous improvement process to talent. The method 350 includes assessing, by a performance management module executed by the computer processor, each of a plurality of workers, using an assessment test evaluating a plurality of performance characteristics (352). The assessment may occur as described above in connection with FIG. 3A, 302. The method 350 includes correlating, by the performance management module, each assessment with actual performance by each of the plurality of workers (354). The correlation may occur as described above in connection with FIG. 3A, 304. The method 350 includes identifying, by the performance management module, at least one highly-correlated leading indicator of performance (356). The correlation may occur as described above in connection with FIG. 3A, 306. The method 350 includes modifying, by an applicant tracking module executed by the computer processor, a hiring process to incorporate the identified at least one highly-correlated leading indicator of performance (358). The modification may occur as described above in connection with FIG. 3A, 308. The method 350 includes providing, by the applicant tracking module, to a candidate for hire, an assessment test including at least one question aimed at determining whether the candidate for hire possesses the identified at least one highly-correlated leading indicator of performance (360). The assessment test may be provided as described above in connection with FIG. 3A. The method 350 includes evaluating, by the applicant tracking module, whether a candidate for hire demonstrates the identified at least one highly-correlated leading indicator of performance (362). The evaluation may occur as described above in connection with FIG. 3A, 310. The method 350 includes determining, by the applicant tracking module, whether to hire the candidate based on the evaluation (364). The evaluation may occur as described above in connection with FIG. 3A, 312.

In some embodiments, the system 200 includes functionality for determining whether the identified leading indicators of performance were in fact as highly correlated with success as the initial analysis suggested. In some embodiments, the onboarding module 220 may provide functionality for surveying a candidate hired as a result of the process described above as well as surveying at least one of the candidate's peers or managers (e.g., a “360” review). In one of these embodiments, the onboarding module 220 provides functionality allowing a user to trigger a review of the hired candidate (or to schedule future reviews) and her peers and/or managers. In another of these embodiments, the onboarding module 220 tracks employees' dates of hire in order to distinguish more recent hires from longer-term employees who may have been hired using different indicators of performance Additionally, by tracking date of hire, the system 200 may provide functionality for generating a report that distinguishes employee performance based on their length of employment, allowing users to review the performance of more recent hires in comparison to less recent or long-term employees. In still another of these embodiments, users of the system 200 may specify when the reviews will take place. For example, the reviews could be set at distinct times during the onboarding process such that the result sets could be used to determine characteristics such as a level of quality of onboarding or a level of quality of hire; a rolling review period could be charted to determine whether a level of quality of onboarding or a level of quality of hire was improving over time. In other embodiments, however, the onboarding module 220 is optional.

In one embodiment, the system applies the methods described above continuously to incorporate assessments of newly hired employees. For example, the methods described above may include assessing, by the performance management module, the hired candidate using the assessment test evaluating the plurality of performance characteristics; correlating, by the performance management module, each assessment with actual performance by the hired candidate; identifying, by the performance management module, an additional highly-correlated leading indicator of performance; modifying, by the applicant tracking module, the hiring process to incorporate the identified additional highly-correlated leading indicator of performance; providing, by the applicant tracking module, to a second candidate for hire, the assessment test including at least one question aimed at determining whether the candidate for hire possesses the identified additional highly-correlated leading indicator of performance; evaluating, by the applicant tracking module, whether the candidate for hire demonstrates the identified additional highly-correlated leading indicator of performance; and determining, by the applicant tracking module, whether to hire the second candidate based on the evaluation. The continuously gathered data may be compiled for additional analyses.

In some embodiments, implementation of the methods and systems described herein allows users to continuously improve their hiring processes as they iterate through cycles of hiring, onboarding, and performance review. In one of these embodiments, users may see continuous improvement to the hiring process because the pool of employees from which indicators of top performance are derived will improve over time as the system gets better at identifying the true indicators of top performance. In another of these embodiments, use of the functionality provided by the applicant tracking module 210 enables the automation of continuous improvement of talent by enabling the hiring and review systems to work together by feeding each other with the relevant and important information required to run the continuous improvement cycle with minimum human intervention.

In some embodiments, due to the dynamic nature of employment in conventional environments, companies may implement the methods and systems described herein to manage hiring processes in a quantitative (e.g., measurable, data-based) way, without bias, and without requiring human intervention; given that humans are typically unable to eliminate bias (and, as is the case with unconscious bias, may not even be aware of the bias), such an implementation improves hiring processes by making the processes more fact-based and transparent. Furthermore, given the dynamic nature of employment, the rate of turnover leads to dynamically changing requirements for, and definitions of, success that humans may not be able to perceive, much less measure and address with modified hiring processes.

It should be understood that the systems described above may provide multiple ones of any or each of the described components and that these components may be provided on either a standalone machine or, in some embodiments, on multiple machines in a distributed system. It should also be understood that phrases such as “based on” and “based upon” do not imply “based exclusively on” and instead generally mean that the particular feature, structure, step, or characteristic is based at least in part on the specified element. Further, the phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, Python, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for applying a continuous improvement process to talent, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method performed by at least one computer processor executing computer program instructions stored on at least one non-transitory computer-readable medium, wherein the computer program instructions are executable by the at least one computer processor to perform a method comprising:
assessing, by a performance management module executed by the computer processor, each of a plurality of workers, using an assessment test evaluating a plurality of performance characteristics;
correlating, by the performance management module, each assessment with actual performance by each of the plurality of workers;
identifying, by the performance management module, at least one highly-correlated leading indicator of performance;
modifying, by an applicant tracking module executed by the computer processor, a hiring process to incorporate the identified at least one highly-correlated leading indicator of performance;
providing, by the applicant tracking module, to a candidate for hire, an assessment test including at least one question aimed at determining whether the candidate for hire possesses the identified at least one highly-correlated leading indicator of performance;
evaluating, by the applicant tracking module, whether the candidate for hire demonstrates the identified at least one highly-correlated leading indicator of performance; and
determining, by the applicant tracking module, whether to hire the candidate based on the evaluation.

2. The method of claim 1 further comprising analyzing, by the performance management module, performance data to identify at least one factor that differentiates a top performer in the plurality of workers from a worker with a lower performance ranking than the top performer.

3. The method of claim 1, wherein identifying further comprises quantitatively identifying, by the performance management module, the at least one highly-correlated leading indicator of performance.

4. The method of claim 1, wherein determining further comprises determining, by the computer processor, to automatically route the candidate for hire to an additional step of the hiring process, based on a determination that the candidate for hire possesses the at least one highly-correlated leading indicator of performance.

5. The method of claim 1 further comprising:
assessing, by the performance management module, the hired candidate using the assessment test evaluating the plurality of performance characteristics;
correlating, by the performance management module, each assessment with actual performance by the hired candidate;
identifying, by the performance management module, an additional highly-correlated leading indicator of performance;
modifying, by the applicant tracking module, the hiring process to incorporate the identified additional highly-correlated leading indicator of performance;
providing, by the applicant tracking module, to a second candidate for hire, the assessment test including at least one question aimed at determining whether the candidate for hire possesses the identified additional highly-correlated leading indicator of performance;
evaluating, by the applicant tracking module, whether the candidate for hire demonstrates the identified additional highly-correlated leading indicator of performance; and
determining, by the applicant tracking module, whether to hire the second candidate based on the evaluation.

6. A computer-readable medium comprising computer-readable instructions tangibly stored on the computer-readable medium, wherein the instructions are executable by at least one processor to perform a method comprising:
assessing, by a performance management module executed by the computer processor, each of a plurality of workers, using an assessment test evaluating a plurality of performance characteristics;
correlating, by the performance management module, each assessment with actual performance by each of the plurality of workers;
identifying, by the performance management module, at least one highly-correlated leading indicator of performance;
modifying, by an applicant tracking module executed by the computer processor, a hiring process to incorporate the identified at least one highly-correlated leading indicator of performance;
providing, by the applicant tracking module, to a candidate for hire, an assessment test including at least one question aimed at determining whether the candidate for hire possesses the identified at least one highly-correlated leading indicator of performance;
evaluating, by the applicant tracking module, whether the candidate for hire demonstrates the identified at least one highly-correlated leading indicator of performance; and
determining, by the applicant tracking module, whether to hire the candidate based on the evaluation.

7. The computer-readable medium of claim 6 further comprising analyzing, by the performance management module, performance data to identify at least one factor that differentiates a top performer in the plurality of workers from a worker with a lower performance ranking than the top performer.

8. The computer-readable medium of claim 6, wherein identifying further comprises quantitatively identifying, by the performance management module, the at least one highly-correlated leading indicator of performance.

9. The computer-readable medium of claim 6, wherein determining further comprises determining, by the computer processor, to automatically route the candidate for hire to an additional step of the hiring process, based on a determination that the candidate for hire possesses the at least one highly-correlated leading indicator of performance.

10. The computer-readable medium of claim 6 further comprising:
assessing, by the performance management module, the hired candidate using the assessment test evaluating the plurality of performance characteristics;
correlating, by the performance management module, each assessment with actual performance by the hired candidate;
identifying, by the performance management module, an additional highly-correlated leading indicator of performance;
modifying, by the applicant tracking module, the hiring process to incorporate the identified additional highly-correlated leading indicator of performance;
providing, by the applicant tracking module, to a second candidate for hire, the assessment test including at least one question aimed at determining whether the candidate for hire possesses the identified additional highly-correlated leading indicator of performance;
evaluating, by the applicant tracking module, whether the candidate for hire demonstrates the identified additional highly-correlated leading indicator of performance; and
determining, by the applicant tracking module, whether to hire the second candidate based on the evaluation.
